(19) United States
(12) Patent Application Publication
(10) Pub. No.: US 2026/0322939 A1
(43) Pub. Date: Oct. 15, 2026

(54) IMAGE PROCESSOR, IMAGE READING DEVICE, IMAGE FORMING APPARATUS, IMAGE PROCESSING METHOD, AND SORTING APPARATUS

(71) Applicant: Kohsuke NAMBARA, Kanagawa (JP)

(72) Inventor: Kohsuke NAMBARA, Kanagawa (JP)

(73) Assignee: ETRIA CO., LTD., Yokohama (JP)

(21) Appl. No.: 19/467,138

(22) Filed: Feb. 2, 2026

(30) Foreign Application Priority Data
Mar. 11, 2025 (JP) 2025-038790

(51) Int. Cl. H04N 1/387; H04N 1/00; H04N 1/028

(52) U.S. Cl. CPC H04N 1/3878; H04N 1/00809; H04N 1/02815; H04N 2201/0081

(57) ABSTRACT

An image processor includes circuitry configured to obtain a difference image from a difference between a first image of an object and a background member read by a scanner at a first wavelength and a second image of the object and the background member read by the scanner at a second wavelength different from the first wavelength; and detect a boundary between the object and the background member based on the difference image obtained.

### CROSS-REFERENCE TO RELATED APPLICATIONS

This patent application is based on and claims priority pursuant to 35 U.S.C. § 119(a) to Japanese Patent Application No. 2025-038790, filed on Mar. 11, 2025, in the Japan Patent Office, the entire disclosure of which is hereby incorporated by reference herein.

### BACKGROUND

### Technical Field

The present disclosure relates to an image processor, an image reading device, an image forming apparatus, an image processing method, and a sorting apparatus.

### Related Art

In the related art, there is a technique for detecting a boundary between a reading target, such as a document, and a background member. The technique uses, for detection, a visible image and an invisible image respectively read at a wavelength of visible light and a wavelength of invisible light by a scanner.

### SUMMARY

The present disclosure herein provides an image processor including circuitry configured to obtain a difference image from a difference between a first image of an object and a background member read by a scanner at a first wavelength and a second image of the object and the background member read by the scanner at a second wavelength different from the first wavelength; and detect a boundary between the object and the background member based on the difference image obtained.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic cross-sectional view of an example of an image forming apparatus according to a first embodiment of the present disclosure;

FIG. 2 is a schematic cross-sectional view of an example of a scanner of the image forming apparatus illustrated in FIG. 1;

FIG. 3 is a schematic cross-sectional view of an example of an automatic document feeder (ADF) of the image forming apparatus illustrated in FIG. 1;

FIG. 4 is a diagram schematically illustrating an example of a configuration around a document reading position;

FIG. 5 is a block diagram illustrating an example of a hardware configuration of the image forming apparatus;

FIG. 6 is a diagram illustrating an example of functions of an image reading device according to the first embodiment;

FIG. 7 is a graph illustrating an example of reflectance at each wavelength according to the first embodiment;

FIGS. 8A, 8B, and 8C are diagrams illustrating examples of read images and a difference image in the first embodiment;

FIGS. 9A and 9B are flowcharts of an example of a procedure of a boundary detection process according to the first embodiment;

FIG. 10 is a diagram illustrating an example of functions of an image reading device according to a second embodiment of the present disclosure;

FIG. 11 is a graph illustrating an example of reflectance at each wavelength according to the second embodiment;

FIGS. 12A and 12B are diagrams illustrating an example of an effect of the second embodiment;

FIG. 13 is a diagram illustrating an example of functions of an image reading device when near-infrared light is used;

FIG. 14 is a graph illustrating an example of light-receiving sensitivity characteristics of an image sensor using silicon;

FIG. 15 is a diagram illustrating an example of functional blocks of image processing circuitry according to a third embodiment of the present disclosure;

FIG. 16 is a graph illustrating an example of reflectance at each wavelength according to the third embodiment;

FIGS. 17A and 17B are diagrams illustrating an example of an effect of the third embodiment;

FIGS. 18A and 18B are flowcharts of an example of a procedure of a boundary detection process according to the third embodiment;

FIG. 19 is a diagram illustrating an example of functional blocks of image processing circuitry according to a fourth embodiment of the present disclosure;

FIG. 20 is a graph illustrating an example of reflectance at each wavelength according to the fourth embodiment;

FIGS. 21A, 21B, and 21C are diagrams illustrating an example of an effect of the fourth embodiment;

FIG. 22 is a flowchart of an example of a procedure of a selection process performed by a detection image selection unit;

FIG. 23 is a diagram illustrating an example of functional blocks of image processing circuitry according to a fifth embodiment of the present disclosure;

FIG. 24 is a diagram illustrating an example of a tilt angle determined from edge point clouds;

FIG. 25 is a diagram illustrating an example of functional blocks of image processing circuitry according to a sixth embodiment of the present disclosure;

FIG. 26 is a diagram illustrating an example of size detection;

FIG. 27 is a diagram illustrating an example of functional blocks of image processing circuitry according to a seventh embodiment of the present disclosure;

FIGS. 28A and 28B are diagrams illustrating an example of tilt correction;

FIG. 29 is a diagram illustrating an example of functional blocks of image processing circuitry according to an eighth embodiment of the present disclosure;

FIGS. 30A and 30B are diagrams illustrating an example of document image clipping; and

FIG. 31 is a diagram illustrating an example of a configuration of a sorting apparatus according to a ninth embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

In a comparative example, a special background member having a strong absorption characteristic only in a wavelength range of invisible light is used to produce a significant difference in read values of the background between a visible image and an invisible image, so that robust edge detection is performed.

In the comparative example, however, it is difficult to detect a boundary when the difference in reflectance between the reading target and the background member is small across all the wavelengths of visible light and invisible light.

Embodiments of the present disclosure allow a boundary to be accurately detected when the difference in reflectance between the reading target and the background member is small across all the wavelengths of visible light and invisible light.

An image processor, an image reading device, an image forming apparatus, an image processing method, and a sorting apparatus according to embodiments of the present disclosure will be described in detail below with reference to the accompanying drawings.

### First Embodiment

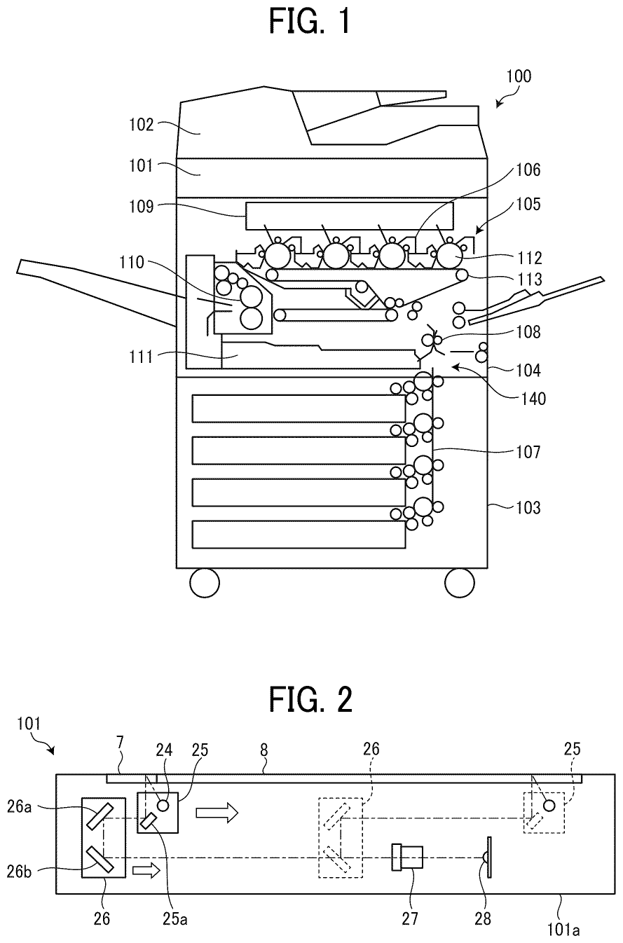

FIG. 1 is a schematic cross-sectional view of an example of an image forming apparatus 100 according to a first embodiment of the present disclosure. The image forming apparatus 100 is a multifunction peripheral (MFP) having at least two functions among a copy function, a printer function, a scanner function, and a facsimile function.

As illustrated in FIG. 1, the image forming apparatus 100 includes a sheet feeder 103, an apparatus body 104, a scanner 101, and an ADF 102.

The image forming apparatus 100 includes a plotter 140, which is an image forming device, inside the apparatus body 104. The plotter 140 includes an image formation section 105 of a tandem system, registration rollers 108, an optical writing device 109, a fixing device 110, and a duplex tray 111. The registration rollers 108 feed a recording sheet from the sheet feeder 103 to the image formation section 105 along a conveyance path 107.

The image formation section 105 includes four photoconductor drums 112 arranged side by side to correspond to four colors of yellow (Y), magenta (M), cyan (C), and key (or black) (K). Each of the photoconductor drums 112 is provided with image formation components therearound which include a charger, a developing device 106, a transfer device, a cleaner, and a charge neutralizer.

An intermediate transfer belt 113, stretched around a drive roller and a driven roller, is disposed in between the transfer devices and the respective photoconductor drums 112.

In the image forming apparatus 100 of the tandem system thus configured, the scanner 101 reads a document, which is a reading target or an object to be read, fed from the ADF 102 to obtain a read document image. Based on the read document image, the optical writing device 109 performs optical writing on the photoconductor drums 112 for the respective colors of Y, M, C, and K on a color-by-color basis to form respective latent images. The developing device 106 develops the latent images with toner of the respective colors to form respective toner images. The transfer device transfers the toner images onto the intermediate transfer belt 113 in order of Y, M, C, and K, for example (primary transfer). A full-color image in which four colors are superimposed together in the primary transfer is transferred onto a recording sheet supplied from the sheet feeder 103 (secondary transfer), and is fixed on the recording sheet by the fixing device 110. The recording sheet is then ejected. In this manner, the image forming apparatus 100 forms the full-color image on the recording sheet. The reading target is not limited to a document and may be any target that is readable with the scanner 101.

The scanner 101 will be described.

FIG. 2 is a schematic cross-sectional view of the scanner 101. As illustrated in FIG. 2, the scanner 101 includes a first carriage 25, a second carriage 26, an imaging lens 27, and an imager 28, which are disposed inside a body frame 101a of the scanner 101.

Inside the body frame 101a of the scanner 101, a first rail and a second rail extend in a sub-scanning direction (left-right direction in FIG. 2). The first rail includes two rails disposed with a predetermined space therebetween in a main-scanning direction (i.e., a direction orthogonal to the paper of FIG. 2) perpendicular to the sub-scanning direction. The second rail has substantially the same configuration as the first rail.

The first carriage 25 is slidably attached to the first rail. The first carriage 25 is reciprocally movable in the sub-scanning direction between a position indicated by a solid line and a position indicated by a dashed line in FIG. 2, by a drive motor via a first carriage drive wire. The first carriage 25 includes a light source 24 and a first mirror member 25a. The light source 24 is an example of a light source.

The second carriage 26 is slidably attached to the second rail. The second carriage 26 is reciprocally movable in the sub-scanning direction between a position indicated by a solid line and a position indicated by a dashed line in FIG. 2, by a drive motor via a second carriage drive wire. The second carriage 26 includes a second mirror member 26a and a third mirror member 26b.

In the case of sheet-through reading using the ADF 102, the first carriage 25 and the second carriage 26 stop at the respective positions indicated by the solid lines in FIG. 2, and the scanner 101 reads a document conveyed by the ADF 102. In the case of flatbed reading in which a document placed on a contact glass 8 is read, the first carriage 25 and the second carriage 26 move in the sub-scanning direction at a speed ratio of 2:1 and the document is read. In the flatbed reading, with such a relationship between the moving speeds, an optical path length of light from the document surface to the imaging lens 27 is kept constant even when the first carriage 25 and the second carriage 26 move.

Reflected light from the document is incident onto the imaging lens 27 through a slit glass 7, the contact glass 8, and the mirror members. The imaging lens 27 focuses the reflected light onto the imager 28 to form an image on the imager 28. The imager 28 includes imaging elements such as charge coupled devices (CCD). The imager 28 performs photoelectric conversion on a reflected light image of the document formed through the imaging lens 27 to obtain an analog image signal. The imager 28 performs analog-to-digital conversion on the analog image signal to obtain a digital image signal, which is a read image, and outputs the digital image signal. The digital image signal is hereinafter referred to as image data or an image.

The ADF 102 mounted on the scanner 101 will be described.

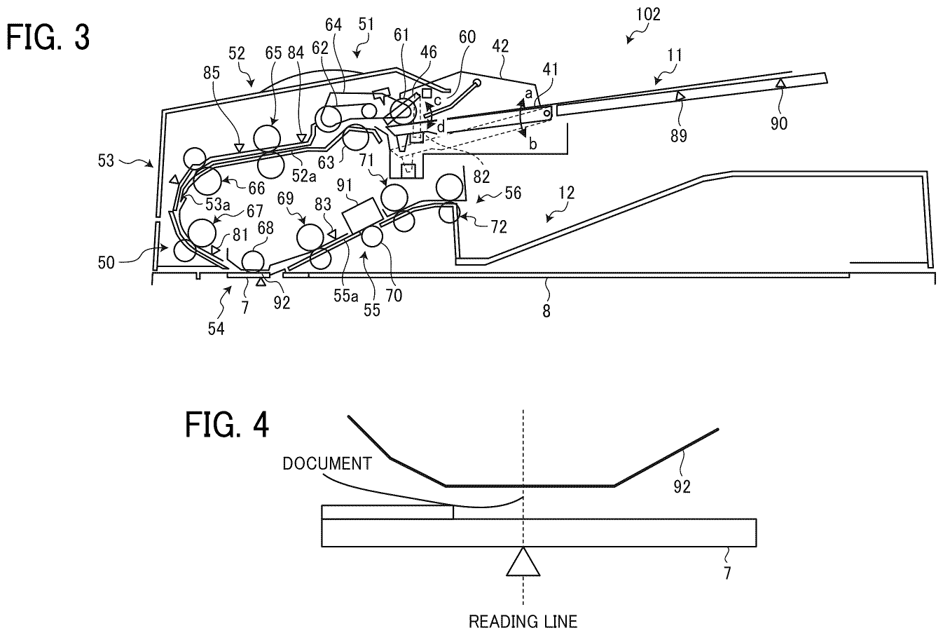

FIG. 3 is a schematic cross-sectional view of the ADF 102. As illustrated in FIG. 3, the ADF 102 includes a document tray 11 on which a document is placed. The document tray 11 includes a movable document table 41 and a pair of side guide plates 42. The movable document table 41 rotates about a proximal end thereof in directions indicated by arrows a and b in FIG. 3. The pair of side guide plates 42 aligns the document laterally with respect to the direction in which the document is fed. With the rotation of the movable document table 41, the leading edge of the document in the document feeding direction is adjusted to an appropriate height.

The document tray 11 has document length detection sensors 89 and 90 spaced apart in the document feeding direction. The document length detection sensors 89 and 90 detect whether the orientation of the document is portrait or landscape. Examples of the document length detection sensors 89 and 90 include reflective sensors that perform detection in a non-contact manner by optical means, and contact actuator-type sensors.

The pair of side guide plates 42 is slidable in the left-right direction with respect to the document feeding direction on one side thereof to allow various-sized documents to be placed on the document tray 11.

The pair of side guide plates 42 is provided with, on the fixed side thereof, a set feeler 46 that rotates in response to placement of a document. A document placement sensor 82 is provided at the lowermost position on a movement trajectory of the tip of the set feeler 46 to detect placement of a document on the document tray 11. That is, the document placement sensor 82 detects whether a document is placed on the ADF 102 based on whether the set feeler 46 rotates to be separate from the document placement sensor 82.

The ADF 102 includes a conveyor 50 including a document separating and feeding section 51, a pullout section 52, a turn section 53, a first reading and conveying section 54, a second reading and conveying section 55, and a document ejecting section 56. The conveyor 50 includes conveyance rollers that are driven to rotate by one or more conveyance motors.

The document separating and feeding section 51 includes a pickup roller 61, a document feed belt 62, and a reversing roller 63. The pickup roller 61 is disposed in the vicinity of a document feed port 60 from which a document is fed. The document feed belt 62 and the reversing roller 63 are disposed to face each other with a conveyance path therebetween.

The pickup roller 61 is supported by a support arm member 64 attached to the document feed belt 62 to move up and down in directions indicated by arrows c and d in FIG. 3 via a cam mechanism between a contact position where the pickup roller 61 comes into contact with a document bundle and a separate position where the pickup roller 61 is separate from the document bundle. The pickup roller 61 picks up several documents (ideally, a single document) from the document bundle placed on the document tray 11 at the contact position.

The document feed belt 62 rotates in the document feeding direction. The reversing roller 63 rotates in an opposite direction to the document feeding direction. When multiple documents are fed, the reversing roller 63 rotates in the opposite direction to the rotation direction of the document feed belt 62. When the reversing roller 63 is in contact with the document feed belt 62 or when a single document is fed, the reversing roller 63 rotates together with the document feed belt 62 by the action of a torque limiter. Consequently, multi-feed of documents is prevented.

The pullout section 52 includes pullout rollers 65 that are a pair of rollers disposed with a conveyance path 52a therebetween. The pullout section 52 performs primary edge alignment (so-called skew correction) on the document fed at driving timings of the pullout rollers 65 and the pickup roller 61, and pulls out and conveys the aligned document.

The turn section 53 includes a pair of intermediate rollers 66 and a pair of reading entrance rollers 67, each of which is disposed with a conveyance path 53a therebetween. The conveyance path 53a curves from top toward bottom. In the turn section 53, the intermediate rollers 66 convey the pulled out and conveyed document along the curved conveyance path 53a to turn the document. The reading entrance rollers 67 convey the document to the vicinity of the slit glass 7, which is at the reading position (imaging position), such that the front side of the document faces downward.

The document conveying speed from the pullout section 52 to the turn section 53 is set to be higher than the document conveying speed in the first reading and conveying section 54. This reduces the time taken to convey the document to the first reading and conveying section 54.

The first reading and conveying section 54 includes a first read roller 68 and first reading exit rollers 69. The first read roller 68 is disposed to face the slit glass 7. The first reading exit rollers 69 are located in a conveyance path 55a downstream of the reading. In the first reading and conveying section 54, the first read roller 68 conveys the document that has been conveyed to the vicinity of the slit glass 7, while keeping the front side of the document in contact with the slit glass 7. At this time, the scanner 101 reads the document through the slit glass 7. At this time, the first carriage 25 and the second carriage 26 of the scanner 101 are stopped at the respective home positions. In the first reading and conveying section 54, the first reading exit rollers 69 further convey the document that has been read.

FIG. 4 is a diagram schematically illustrating an example of a configuration around the document reading position. In FIG. 4, the document is conveyed from left to right.

As illustrated in FIG. 4, the ADF 102 includes a background member 92 at a position facing the slit glass 7. The background member 92 serves as a background during imaging. The background member 92 is, for example, white and is used for shading correction. The document is conveyed between the slit glass 7 and the background member 92. The scanner 101 reads an image at a position of a reading line illustrated in FIG. 4.

The second reading and conveying section 55 includes a second reader 91, a second read roller 70, and second reading exit rollers 71. The second reader 91 reads the back side of the document. The second read roller 70 is disposed to face the second reader 91 with the conveyance path 55a therebetween. The second reading exit rollers 71 are disposed downstream from the second reader 91 in the conveyance direction.

In the second reading and conveying section 55, the second reader 91 reads the back side of the document after the front side of the document is read. After the back side of the document is read, the second reading exit rollers 71 convey the document toward a document ejection port. The second read roller 70 functions to prevent or reduce floating of the document at the second reader 91 and also functions as a reference white area when the second reader 91 acquires shading data. When duplex reading is not performed on the document, the document passes through the second reader 91.

The document ejecting section 56 is provided with a pair of document ejection rollers 72 in the vicinity of the document ejection port. The pair of document ejection rollers 72 ejects the document that has been conveyed by the second reading exit rollers 71, onto a document ejection tray 12.

The ADF 102 is provided with various sensors such as a contact sensor 84, a registration sensor 81, and a document ejection sensor 83 along the document conveyance path. The various sensors are used for conveyance control related to a document conveying distance and a document conveying speed, for example.

A document width sensor 85 is disposed between the pullout rollers 65 and the intermediate rollers 66. The length of the document in the conveyance direction is detected based on motor pulses in response to the contact sensor 84 and the registration sensor 81 reading the leading end and the trailing end of the document.

A hardware configuration of the image forming apparatus 100 will be described.

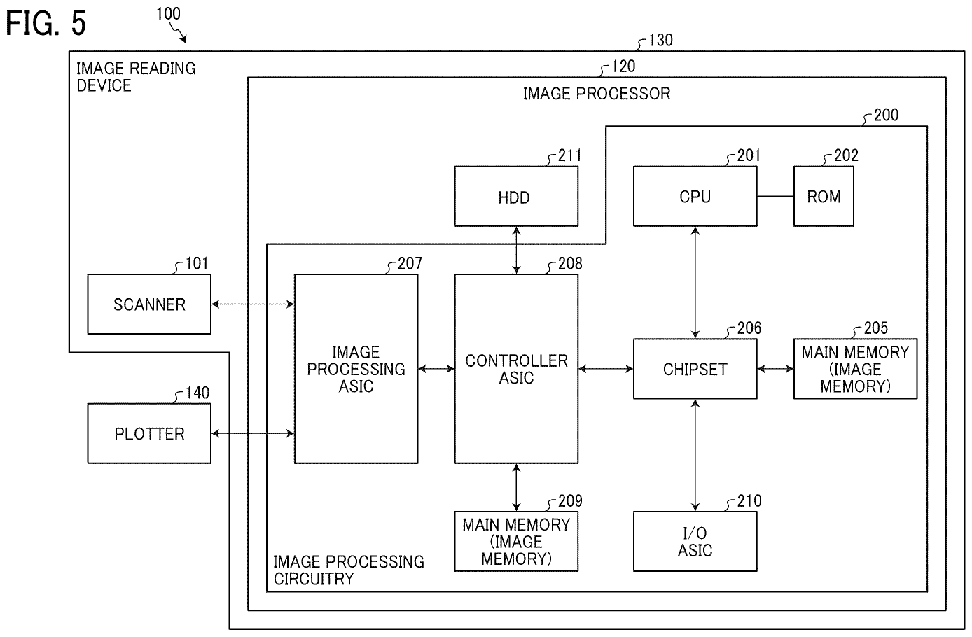

FIG. 5 is a block diagram illustrating an example of the hardware configuration of the image forming apparatus 100. As illustrated in FIG. 5, the image forming apparatus 100 includes the scanner 101, an image processor 120, and the plotter 140. The scanner 101 and the image processor 120 form an image reading device 130 according to the present embodiment.

The scanner 101 has a function of reading, from a document, an image to be subjected to a copy process or an image to be output to an external interface. The image processor 120 performs predetermined processing (e.g., image processing) on the image read by the scanner 101, and outputs the image-processed image data to the plotter 140. The plotter 140 has a function of printing image data. The image processor 120 includes image processing circuitry 200 and a hard disk drive (HDD) 211.

The image processing circuitry 200 includes a central processing unit (CPU) 201, a read-only memory (ROM) 202, a main memory 205, a chipset 206, an image processing ASIC 207, a controller ASIC 208, a main memory 209, and an input/output (I/O) ASIC 210. “ASIC” is an acronym for “application-specific integrated circuit”.

The CPU 201 controls the image forming apparatus 100. The main memory 205 is used as a work area to which a program used by the CPU 201 to control the image forming apparatus 100 is deployed. The main memory 205 is used as an image memory for temporarily storing image data or the like to be handled. The chipset 206 is used together with the CPU 201 to control access to the main memory 205 from the controller ASIC 208 and the I/O ASIC 210.

The image processing ASIC 207 performs image processing on the image read by the scanner 101, and outputs the resulting image data to the controller ASIC 208. The image processing ASIC 207 performs image processing on the image data input from the controller ASIC 208 to make the image data printable by the plotter 140 and transmits the image data to the plotter 140 in accordance with a print timing of the plotter 140.

The controller ASIC 208 uses the main memory 205 via the chipset 206 to, for example, rotate and edit image data handled by the image forming apparatus 100. The controller ASIC 208 stores the image data in the HDD 211, and transmits and receives the image data to and from the image processing ASIC 207. The main memory 209 is used as an image memory with which the controller ASIC 208 performs image processing. The HDD 211 is used for temporarily storing image data on which the image processing has been performed.

The I/O ASIC 210 is an external interface for providing additional functions to the image forming apparatus 100. For example, the I/O ASIC 210 includes a network interface, interfaces for a Universal Serial Bus (USB), a Secure Digital (SD) card, an operation member, a Serial Peripheral Interface (SPI), an Inter-Integrated Circuit (I2C), and the document width sensor 85, a hardware accelerator for accelerating image processing, and an encryption processing circuit.

Functions exerted by the image processing circuitry 200 will be described.

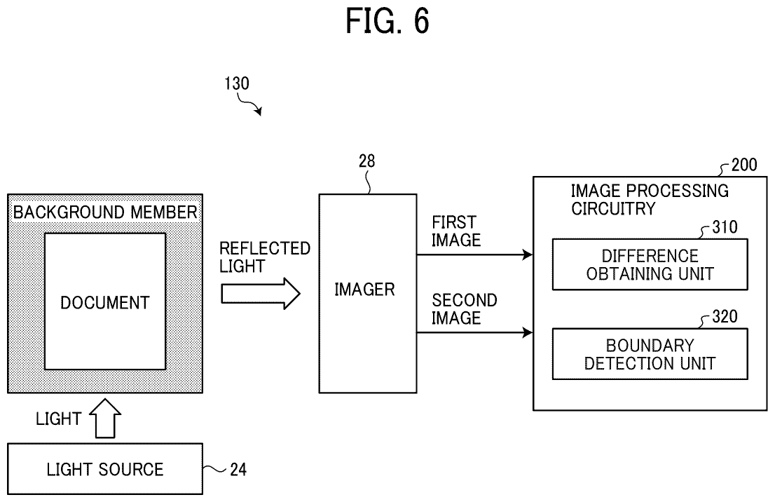

FIG. 6 is a diagram illustrating an example of functions of the image reading device 130 according to the first embodiment. Characteristic functions of the present embodiment among functions exerted by the image reading device 130 will be described.

As illustrated in FIG. 6, the light source 24 irradiates a document, which is the reading target or an object to be read, and the background member 92 (hereinafter, referred to as “background”) with light. The imager 28 images reflected light from the document and the background to acquire two images (i.e., a first image and a second image). The image processing circuitry 200 receives the first image and the second image from the imager 28. The first image is an image of the document and the background read at a first wavelength. The second image is an image of the document and the background read at a second wavelength different from the first wavelength. The first wavelength and the second wavelength may be wavelengths of visible light or wavelengths of invisible light.

The image processing circuitry 200 includes, as functional blocks (functional units), a difference obtaining unit 310 and a boundary detection unit 320. In the present embodiment, for example, the controller ASIC 208 has the difference obtaining unit 310 and the boundary detection unit 320. The configuration is not limited to this example. For example, the CPU 201 executes a program to implement the difference obtaining unit 310 and the boundary detection unit 320.

The difference obtaining unit 310 obtains a difference image based on a difference between the first image and the second image. The first image and the second image are read images obtained by reading the document and the background at the same position. Each pixel of the first image has a read value obtained at the first wavelength. Each pixel of the second image has a read value obtained at the second wavelength. For example, each pixel of the difference image has a differential value obtained by subtracting a pixel value at each pixel position in the second image from a pixel value at a corresponding pixel position in the first image.

When the differential value is negative, the pixel value of the difference image may be set to 0 or an absolute value of the differential value. A difference image may be obtained which has pixel values obtained by adding an offset to the differential values to avoid negative pixel values.

Based on the difference image, the boundary detection unit 320 detects a boundary between the document and the background. For example, a first derivative filter is applied to the difference image. The filtering result is binarized using a predetermined threshold value to extract an edge point cloud. In this way, the boundary detection unit 320 detects a boundary. The edge point cloud is multiple pixels (pixel group) indicating the position of the boundary. For example, the boundary detection unit 320 sets a line linking the extracted edge point cloud as the boundary or sets an approximate straight line determined using a least squares method or the like as a boundary line to detect the boundary.

The predetermined threshold value used in binarization of the result of the first derivative filtering is a value set in advance based on an experiment, for example. As the predetermined value, a single value may be set or different values may be set for different document types. The predetermined value may dynamically change in accordance with the usage state of the scanner 101.

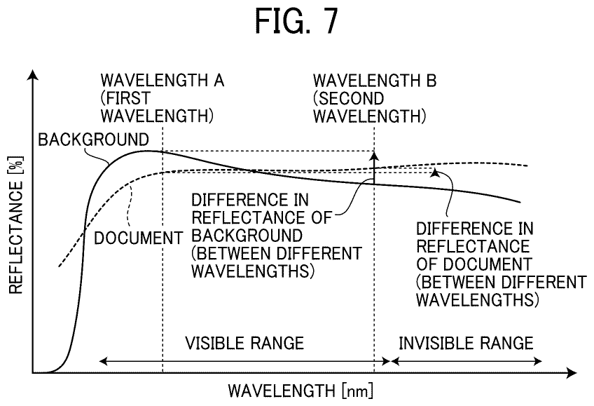

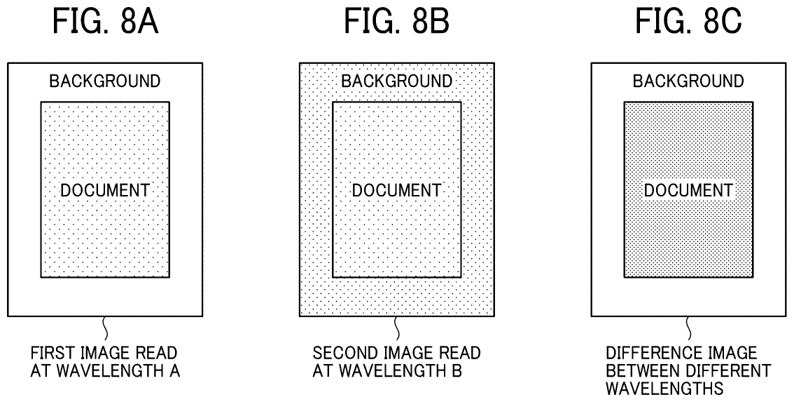

An effect of the present embodiment will be described with reference to FIGS. 7, 8A, 8B, and 8C. FIG. 7 is a graph illustrating an example of reflectance at each wavelength according to the first embodiment. Curves illustrated in FIG. 7 represent spectral reflectance characteristics of the document and the background. The horizontal axis of the graph represents the wavelength of the emitted light, and the vertical axis of the graph represents the reflectance of the document and the background. A solid line represents the reflectance of the background. A dashed line represents the reflectance of the document.

In the example illustrated in FIG. 7, the reflectance of the background and the reflectance of the document do not differ greatly from a visible range to an invisible range. Therefore, in the related art, it is difficult to detect the boundary or a special member having reflectance different from that illustrated in FIG. 7 is used as the background for boundary detection. In contrast, in the present embodiment, the fact that the slope of the spectral reflectance characteristics differs between the background and the document is used, and the boundary is detected using the difference image obtained from the difference between the first image and the second image.

In the example illustrated in FIG. 7, the reflectance of the background has a characteristic that the curve lowers toward the right as the wavelength increases. Conversely, the reflectance of the document has a characteristic that the curve gradually rises toward the right as the wavelength increases. When the direction of the slope of the spectral reflectance characteristics differs between the background and the document or when the magnitude of the slope differs between the background and the document, the difference image obtained from the first image and the second image has different pixel values for the background and the document. Thus, the boundary is detectable using the difference image.

As illustrated in FIG. 7, the first wavelength is a wavelength A that is a shorter wavelength in the visible range and the second wavelength is a wavelength B that is a longer wavelength in the visible range. In this case, the difference in reflectance of the background (i.e., the difference in reflectance between the wavelength A and the wavelength B) is larger than the difference in reflectance of the document. Thus, the difference image is suitable for boundary detection. In contrast, the difference in reflectance between the background and the document at the wavelength A and the difference in reflectance between the background and the document at the wavelength B are not large. Thus, the first image read at the wavelength A and the second image read at the wavelength B are not suitable for boundary detection.

FIGS. 8A, 8B, and 8C are diagrams illustrating examples of read images and a difference image in the first embodiment. FIG. 8A illustrates an example of the first image. FIG. 8B illustrates an example of the second image. FIG. 8C illustrates an example of the difference image. As illustrated in FIGS. 8A, 8B, and 8C, the difference in pixel value between the background and the document is not large in the first image and the second image. In contrast, the difference in pixel value between the background and the document is large in the difference image. Accordingly, the use of the difference image enables boundary detection for a document that has a small difference in reflectance between the background and the document across the entire wavelength range and thus is difficult to detect a boundary with the related art.

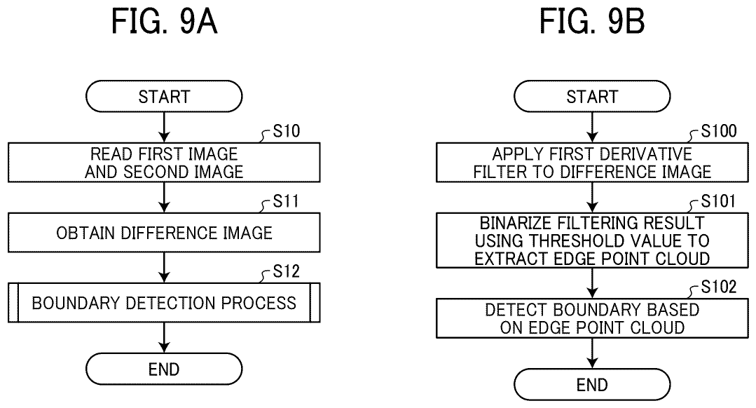

FIGS. 9A and 9B are flowcharts of an example of a procedure of a boundary detection process according to the first embodiment. FIG. 9A illustrates an overview of the procedure from image reading to boundary detection. The imager 28 first reads the first image and the second image in step S10. The difference obtaining unit 310 then obtains the difference image in step S11. Specifically, the difference obtaining unit 310 obtains the difference image from a difference between the first image and the second image. The boundary detection unit 320 then performs the boundary detection process in step S12.

FIG. 9B illustrates an example of steps of the boundary detection process. The boundary detection unit 320 applies the first derivative filter to the difference image in step S100. The boundary detection unit 320 then binarizes a result of the first derivative filtering by using a predetermined threshold value to extract an edge point cloud in step S101. The boundary detection unit 320 then detects the boundary based on the edge point cloud in step S102.

As described above, in the present embodiment, the difference image obtained from the difference between the first image and the second image is used. This allows a boundary to be accurately detected without any increase in the number of components and in processing cost when the difference in reflectance between the reading target and the background member is small across all the wavelengths of visible light and invisible light.

### Second Embodiment

A second embodiment will be described.

In the present embodiment, a wavelength in the visible range (i.e., an invisible wavelength) is used as the first wavelength and a wavelength in the invisible range (i.e., a invisible wavelength) is used as the second wavelength. Description of part of the second embodiment similar to that of the first embodiment will be omitted, and part of the second embodiment different from that of the first embodiment will be described below.

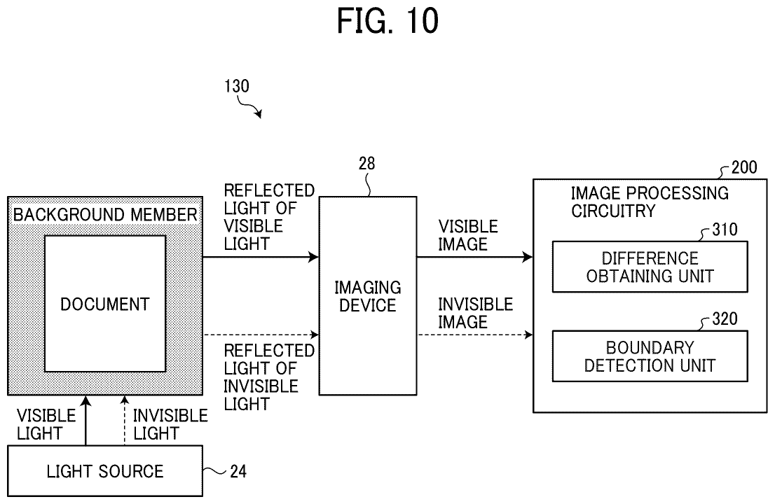

FIG. 10 is a diagram illustrating an example of functions of the image reading device 130 according to the second embodiment. Differences of the present embodiment from the first embodiment are that the light source 24 irradiates the document and the background with light including visible light and invisible light, and that the imager 28 images reflected light including the visible light and the invisible light to obtain a first image read at a wavelength in the visible range and a second image read at a wavelength in the invisible range. In the present embodiment, the first image and the second image are referred to as a visible image and an invisible image, respectively.

The image processing circuitry 200 receives the visible image and the invisible image from the imager 28, and detects the boundary between the background and the document using the difference image as in the first embodiment.

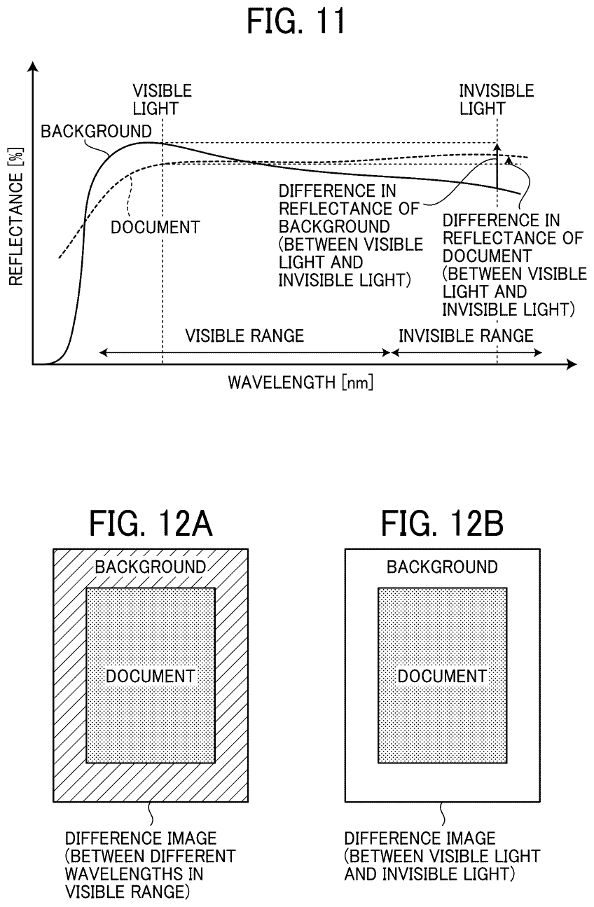

FIG. 11 is a graph illustrating an example of reflectance at each wavelength according to the second embodiment. Since the background desirably has uniform spectral characteristics, the change in spectral characteristics in the visible range is gradual as illustrated in FIG. 11. Thus, when the first wavelength and the second wavelength are selected from the visible range, the pixel value in the difference image may be small in the background.

Likewise, the change in spectral characteristics in the visible range is also gradual for the document. Thus, when the first wavelength and the second wavelength are selected from the visible range, the difference in pixel value between the background and the document in the difference image is small. In the cases described above, boundary detection is difficult.

In the present embodiment, a wavelength in the visible range is used as the first wavelength and a wavelength in the invisible range is used as the second wavelength to obtain the difference image in which the difference in pixel value between the background and the document is large.

FIGS. 12A and 12B are diagrams illustrating an example of an effect of the second embodiment. FIG. 12A illustrates an example of the difference image obtained when the first wavelength and the second wavelength are selected from the visible range. FIG. 12B illustrates an example of the difference image obtained when the first wavelength is selected from the visible range and the second wavelength is selected from the invisible range (i.e., the difference image obtained in the present embodiment).

It is difficult to detect the boundary from the difference image illustrated in FIG. 12A because the difference in pixel value between the background and the document is small. In contrast, the boundary is detectable from the difference image (in FIG. 12B) obtained in the present embodiment because the difference in pixel value between the background and the document is large.

In the present embodiment, the first wavelength is selected from the visible range and the second wavelength is selected from the invisible range to make the difference in pixel value between the background and the document in the difference image larger. This can extend the range of documents in which the boundary is detectable.

As the second wavelength used in the present embodiment, a wavelength of near-infrared (NIR) light is usable. The wavelength range of the near-infrared light is from 750 nm to 2500 nm.

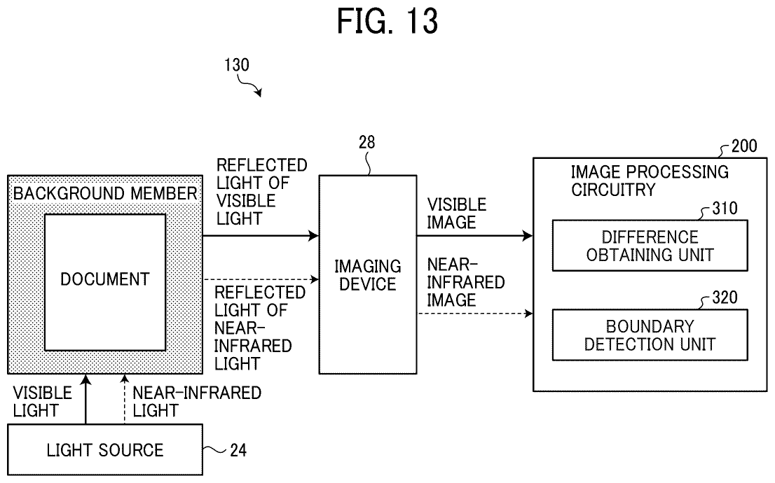

FIG. 13 is a diagram illustrating an example of functions of the image reading device 130 when near-infrared light is used. Differences from FIG. 10 are that the light source 24 irradiates the document and the background with light including near-infrared light as invisible light, and that the imager 28 images reflected light including the near-infrared light to obtain a first image read at a wavelength in the visible range and a second image (near-infrared image) read at a wavelength of the near-infrared light. The image processing circuitry 200 receives the visible image and the near-infrared image from the imager 28, and detects the boundary between the background and the document using the difference image obtained from the received images.

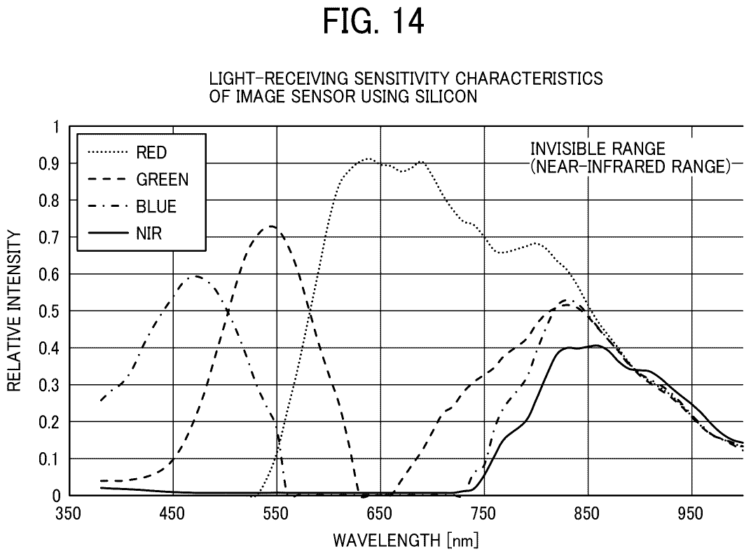

FIG. 14 is a graph illustrating an example of light-receiving sensitivity characteristics of an image sensor using silicon. The image sensor using silicon is, for example, a CCD sensor. As illustrated in FIG. 14, silicon has light-receiving sensitivity characteristics in the near-infrared range. Thus, when the wavelength of near-infrared light is used as the second wavelength, the image sensor using silicon can acquire the near-infrared image. Since silicon is used in general semiconductor devices, the use of the wavelength of near-infrared light as the second wavelength makes it easier to configure the image reading device 130 according to the present embodiment.

As described above, in the present embodiment, the difference image obtained from the difference between the visible image and the invisible image is used. This allows a boundary to be accurately detected without any increase in the number of components and in processing cost when the difference in reflectance between the reading target and the background member is small across all the wavelengths of visible light and invisible light. The difference in pixel value between the background and the document in the difference image can be made larger. This can extend the range of documents in which the boundary is detectable.

### Third Embodiment

A third embodiment will be described.

In the present embodiment, the first wavelength and the second wavelength are selected to maximize the absolute value of the difference between the pixel value of the reading target and the pixel value of the background member in the difference image. Description of part of the third embodiment similar to those of the first and second embodiments will be omitted, and part of the third embodiment different from those of the first and second embodiments will be described below.

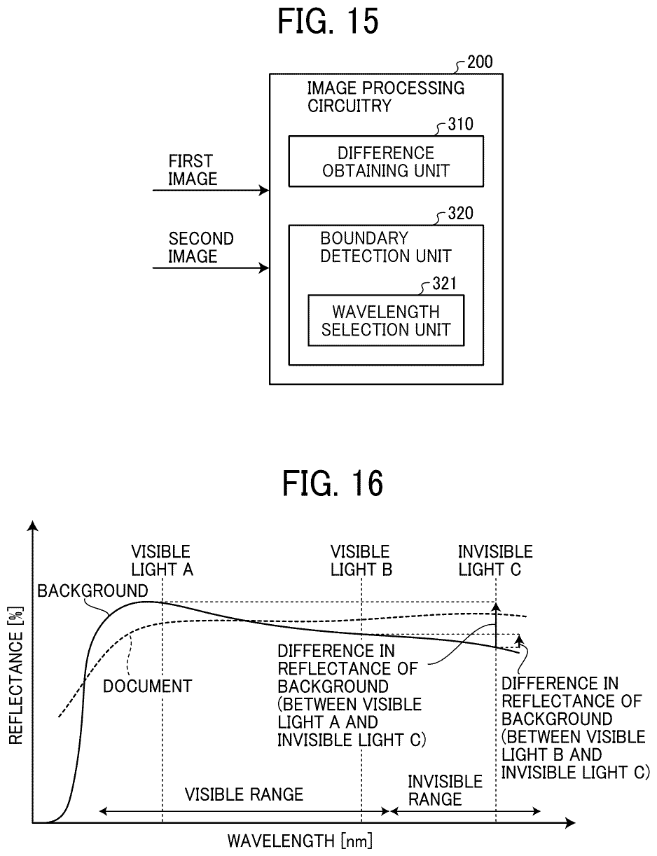

FIG. 15 is a diagram illustrating an example of functional blocks of the image processing circuitry 200 according to the third embodiment. A difference between the third embodiment and the first and second embodiments is that the boundary detection unit 320 includes a wavelength selection unit 321. The wavelength selection unit 321 is included in the boundary detection unit 320 in FIG. 15. However, the wavelength selection unit 321 may be provided outside the boundary detection unit 320.

The wavelength selection unit 321 selects the first wavelength from among multiple first candidates and selects the second wavelength from among multiple second candidates. Specifically, the wavelength selection unit 321 selects the first wavelength and the second wavelength to maximize the absolute value of the difference between the pixel value of the document and the pixel value of the background in the difference image.

FIG. 16 is a graph illustrating an example of reflectance at each wavelength according to the third embodiment. In this example, the first candidates include a wavelength of visible light A and a wavelength of visible light B, and the second candidates include a wavelength of invisible light C. As illustrated in FIG. 16, the spectral reflectance characteristics of the document are substantially flat. Thus, a difference in reflectance between the visible light A and the invisible light C and a difference in reflectance between the visible light B and the invisible light C are both small values.

In contrast, since the spectral reflectance characteristics of the background decrease toward the right, the difference in reflectance between the visible light A and the invisible light C is a large value and the difference in reflectance between the visible light B and the invisible light C is a small value as illustrated in FIG. 16. Accordingly, the absolute value of the difference between the pixel value of the document and the pixel value of the background in the difference image is larger when the wavelength of the visible light A is selected as the first wavelength than when the wavelength of the visible light B is selected as the first wavelength. The wavelength selection unit 321 selects the wavelength of the visible light A from among the first candidates to increase the accuracy of detecting the boundary from the difference image.

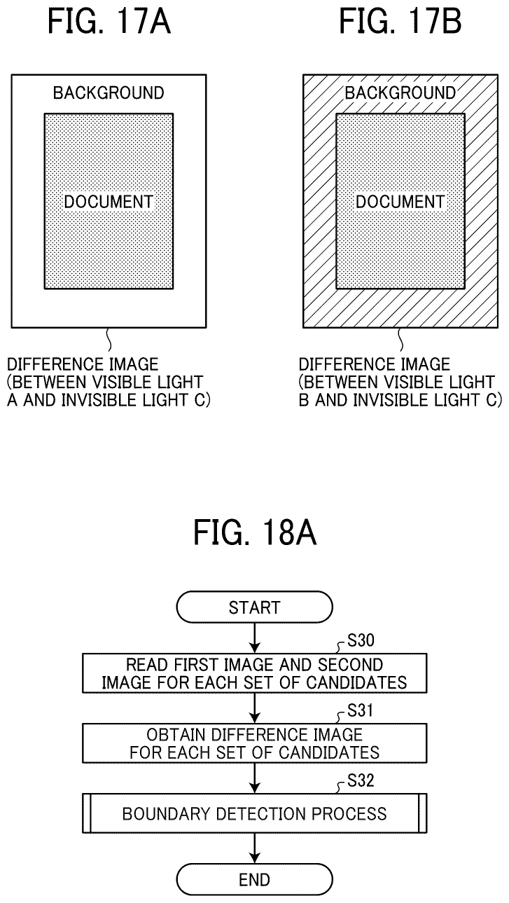

FIGS. 17A and 17B are diagrams illustrating an example of an effect of the third embodiment. FIG. 17A illustrates an example of the difference image obtained when the wavelength of the visible light A is selected as the first wavelength in the example of FIG. 16 (i.e., the difference image obtained in the present embodiment). FIG. 17B illustrates an example of the difference image obtained when the wavelength of the visible light B is selected as the first wavelength in the example illustrated in FIG. 16.

Since the difference in pixel value between the background and the document is small in the difference image illustrated in FIG. 17B, the accuracy of detecting the boundary is low. In contrast, since the difference in pixel value between the background and the document is large in the difference image obtained in the present embodiment (FIG. 17A), the accuracy of detecting the boundary increases. The example in which the first candidates include two wavelengths and the second candidates include one wavelength has been described above. The numbers of wavelengths included in the candidates are not limited to this example. The candidates may include multiple wavelengths, or the first candidates may include one wavelength and the second candidates may include multiple wavelengths.

In the present embodiment, the first wavelength is selected from multiple first candidates and the second wavelength is selected from multiple second candidates to make the difference in pixel value between the background and the document in the difference image larger. This can extend the range of documents in which the boundary is detectable.

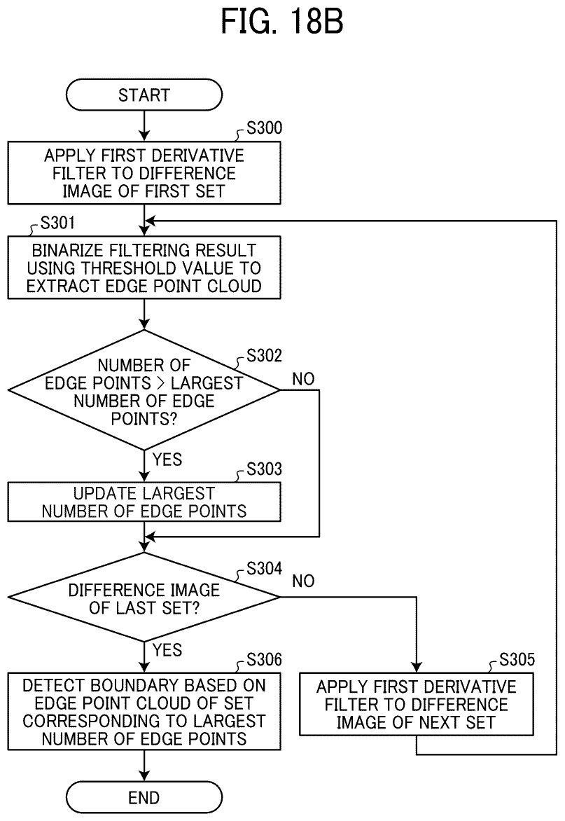

An example of a wavelength selection method according to the present embodiment will be described with reference to FIGS. 18A and 18B. FIGS. 18A and 18B are flowcharts of an example of a procedure of a boundary detection process according to the third embodiment. FIG. 18A illustrates an overview of the procedure from image reading to boundary detection. The imager 28 first reads the first image and the second image for each set of candidates in step S30.

The difference obtaining unit 310 then obtains the difference image for each set of candidates in step S31. The set of candidates is a combination of the first candidate and the second candidate of selected wavelengths. The difference obtaining unit 310 obtains the difference image for all the sets. The boundary detection unit 320 then performs the boundary detection process in step S32.

FIG. 18B illustrates an example of steps of the boundary detection process. The boundary detection unit 320 applies the first derivative filter to the difference image obtained for the first set in step S300. The boundary detection unit 320 then binarizes a result of the first derivative filtering by using a predetermined threshold value to extract an edge point cloud in step S301.

When the number of edge points of the extracted edge point cloud is more than the largest number of edge points (Yes in step S302), the boundary detection unit 320 updates the largest number of edge points in step S303. Specifically, the largest number of edge points is updated to the number of edge points of the extracted edge point cloud. The initial value of the largest number of edge points is 0. When the number of edge points of the extracted edge point cloud is not more than the largest number of edge points (No in step S302), the process proceeds to step S304.

When the difference image being processed is not obtained from the last set (No in step S304), the boundary detection unit 320 applies the first derivative filter to the difference image obtained from the next set in step S305. The process then returns to step S301. When the difference image being processed is obtained from the last set (Yes in step S304), the boundary detection unit 320 detects the boundary using the edge point cloud extracted from the difference image for the set corresponding to the largest number of edge points in step S306.

The image processing circuitry 200 may accumulate, in the HDD 211, the set (the selected set of the first wavelength and the second wavelength) corresponding to the largest number of edge points, determined in advance based on an experiment for each document type. In this case, the wavelength selection unit 321 can select the first wavelength and the second wavelength by reading the set accumulated in the HDD 211 in accordance with the document type selected by the user.

In FIGS. 18A and 18B, the edge point cloud is extracted for all the sets. However, the wavelength selection unit 321 may end the extraction process when the number of edge points of a certain set reaches a predetermined value and select the first wavelength and the second wavelength corresponding to the certain set. This can reduce the amount of processing for selecting the wavelengths. The predetermined value is a value set in advance based on an experiment or the like. For example, the predetermined value is set such that the boundary between the document and the background is accurately detected when the number of edge points exceeds the predetermined value. The wavelength selection unit 321 may select multiple sets for which the number of edge points exceeds the predetermined value, determine a point cloud by OR processing from multiple edge point clouds extracted for the selected sets, and use the determined point cloud to detect the boundary.

As described above, in the present embodiment, the first wavelength is selected from the multiple first candidates and the second wavelength is selected from the multiple second candidates, so that the difference in pixel value between the background and the document in the difference image can be made larger. This allows the boundary to be accurately detected without any increase in the number of components and in processing cost when the difference in reflectance between the reading target and the background member is small across all the wavelengths of visible light and invisible light.

### Fourth Embodiment

A fourth embodiment will be described.

In the present embodiment, at least one of the difference image, the first image, and the second image is selected as a detection image, and the boundary is detected based on the selected detection image. Description of part of the fourth embodiment similar to those of the first to third embodiments will be omitted, and part of the fourth embodiment different from those of the first to third embodiments will be described below.

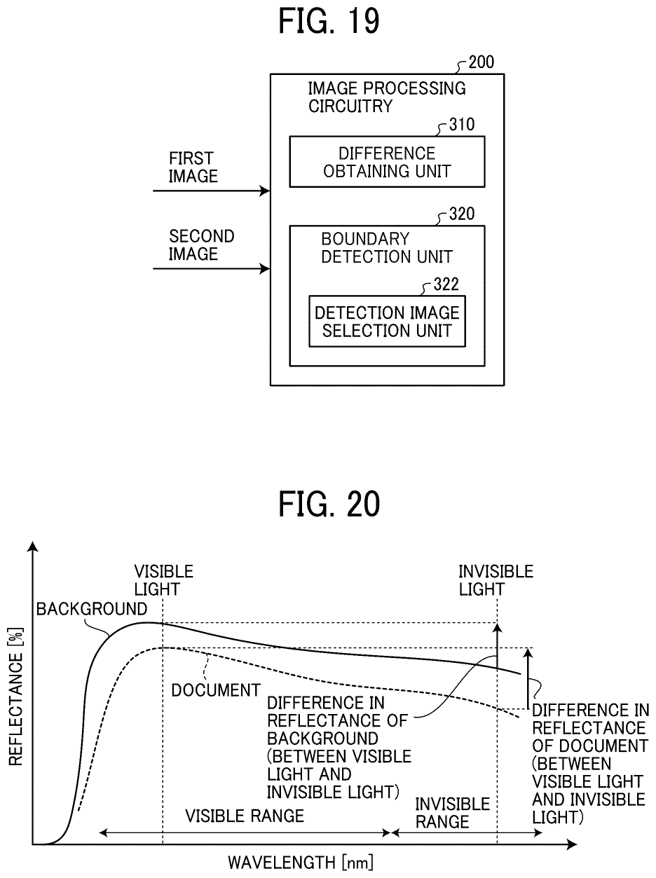

FIG. 19 is a diagram illustrating an example of functional blocks of the image processing circuitry 200 according to the fourth embodiment. A difference between the fourth embodiment and the first to third embodiments is that the boundary detection unit 320 includes a detection image selection unit 322. The detection image selection unit 322 is included in the boundary detection unit 320 in FIG. 19. However, the detection image selection unit 322 may be provided outside the boundary detection unit 320.

The detection image selection unit 322 selects at least one of the difference image, the first image, and the second image as the detection image. For example, the detection image selection unit 322 selects, as the detection image, an image for which the number of edge points extracted using the first derivative filter or the threshold value is greater than or equal to a predetermined value or an image with the largest number of edge points from among the difference image, the first image, and the second image. The boundary detection unit 320 detects the boundary between the document and the background based on the selected detection image.

FIG. 20 is a graph illustrating an example of reflectance at each wavelength according to the fourth embodiment. In this case, slopes of the spectral reflectance characteristics of the background and the document have similar directions and similar magnitudes.

Thus, the difference in reflectance between visible light and invisible light is similar in magnitude between the background and the document.

The difference in reflectance sometimes becomes similar in magnitude between the background and the document not only for the combination of wavelengths illustrated in FIG. 20 but also in other cases regardless of how the first wavelength and the second wavelength are selected. Even in such cases, the present embodiment allows the boundary to be detected from the selected detection image.

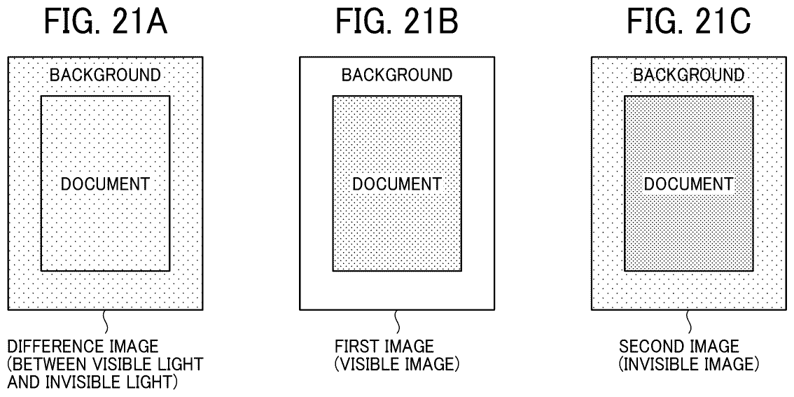

FIGS. 21A, 21B, and 21C are diagrams illustrating an example of an effect of the fourth embodiment. FIG. 21A illustrates an example of the difference image obtained between visible light and invisible light in the example illustrated in FIG. 20. FIGS. 21B and 21C respectively illustrate the first image (visible image) and the second image (invisible image) imaged in the example illustrated in FIG. 20.

Since there is almost no difference in pixel value between the background and the document in the difference image illustrated in FIG. 21A, it is difficult to detect the boundary. In contrast, since there is a difference in pixel value between the background and the document in the first image (FIG. 21B) and the second image (FIG. 21C) each selectable as the detection image in the present embodiment, the boundary is detectable. In this example, the detection image selection unit 322 selects the first image with the largest difference in pixel value between the background and the document.

In the present embodiment, the first image and the second image are added as options of the detection image, so that the detection image that enables accurate boundary detection can be used for the document for which the boundary detection accuracy reduces when the difference image is used. This can increase the types of documents from which the boundary is detectable.

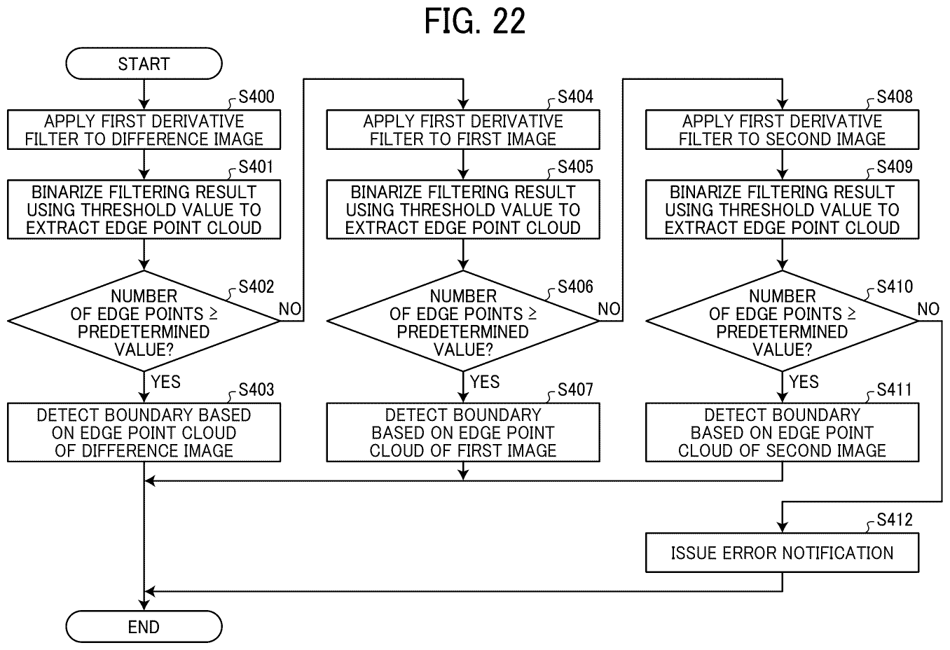

An example of a detection image selection method in the present embodiment will be described with reference to FIG. 22. FIG. 22 is a flowchart of an example of a procedure of a selection process performed by the detection image selection unit 322.

The detection image selection unit 322 applies the first derivative filter to the difference image in step S400. The detection image selection unit 322 then binarizes a result of the first derivative filtering by using a predetermined threshold value to extract an edge point cloud in step S401.

When the number of edge points of the extracted edge point cloud is greater than or equal to a predetermined value (Yes in step S402), the detection image selection unit 322 detects the boundary based on the edge point cloud of the difference image in step S403. When the number of edge points of the extracted edge point cloud is not greater than or equal to the predetermined value (No in step S402), the process proceeds to step S404.

In steps S404 to S407, processing similar to that of steps S400 to S403 is performed for the first image instead of the difference image. In steps S408 to S411, processing similar to that of steps S400 to S403 is performed for the second image instead of the difference image. When the number of edge points exceeds the predetermined value for multiple images, a point cloud may be determined by OR processing from the multiple edge point clouds extracted for these images, and the determined point cloud may be used to detect the boundary.

When the number of edge points is not greater than or equal to the predetermined value in step S410 (No in step S410), the image processing circuitry 200 issues an error notification in step S412. For example, the predetermined value is set such that the boundary between the document and the background is accurately detected when the number of edge points exceeds the predetermined value. When the number of edge points is less than the predetermined value, the boundary between the document and the background is not accurately detectable. Thus, an error notification is issued. The error notification is issued, for example, by displaying a message indicating the boundary is not detectable on an operation panel of the image reading device 130 or by emailing a message indicating the boundary is not detectable to an email address of the user.

In FIG. 22, the number of edge points is determined sequentially for the difference image, the first image, and the second image, and when the number of edge points is greater than or equal to the predetermined value, the image corresponding to the number of edge points is selected as the detection image. However, the image with the largest number of edge points among the difference image, the first image, and the second image may be selected as the detection image. The predetermined value is a value set in advance based on an experiment or the like. As the predetermined value, a single value may be set or different values may be set for the difference image, the first image, and the second image.

The image processing circuitry 200 may accumulate, in the HDD 211, information on a detection image selected in advance based on an experiment for each document type. In this case, the detection image selection unit 322 can select the detection image by reading the information on the detection image accumulated in the HDD 211 in accordance with the document type selected by the user.

As described above, in the present embodiment, at least one of the difference image, the first image, and the second image is selected as a detection image, and the boundary is detected based on the selected detection image. This allows the boundary to be accurately detected using the detection image suitable for the document type.

### Fifth Embodiment

A fifth embodiment will be described.

In the present embodiment, a tilt of the reading target is detected based on the boundary between the reading target and the background member detected by the image processor 120 according to the first to fourth embodiments. Description of part of the fifth embodiment similar to those of the first to fourth embodiments will be omitted, and part of the fifth embodiment different from those of the first to fourth embodiments will be described below.

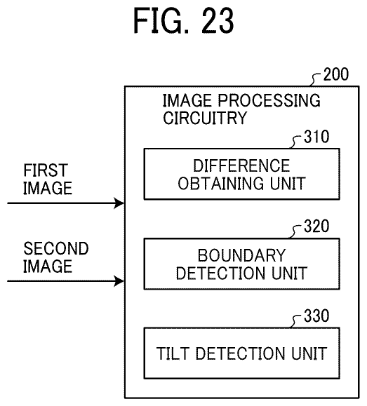

FIG. 23 is a diagram illustrating an example of functional blocks of the image processing circuitry 200 according to the fifth embodiment. A difference between the fifth embodiment and the first to fourth embodiments is that the image processing circuitry 200 further includes a tilt detection unit 330.

The tilt detection unit 330 detects a tilt of the document based on the boundary between the document and the background detected by the boundary detection unit 320. For example, the tilt detection unit 330 uses the least squares method to determine a regression line from the edge point cloud used in the boundary detection, and detects the slope of the regression line as a tilt angle θ of the document. The equation of the regression line may be obtained by calculating one linear equation from all edge points around the boundary of the tilt detection target, or by dividing the boundary into multiple areas, calculating linear equations for the respective areas, and selecting a representative linear equation or integrating the linear equations. Examples of the method used in this case include selecting a linear equation whose slope is the median or taking an average value of the respective linear equations as an integrated linear equation.

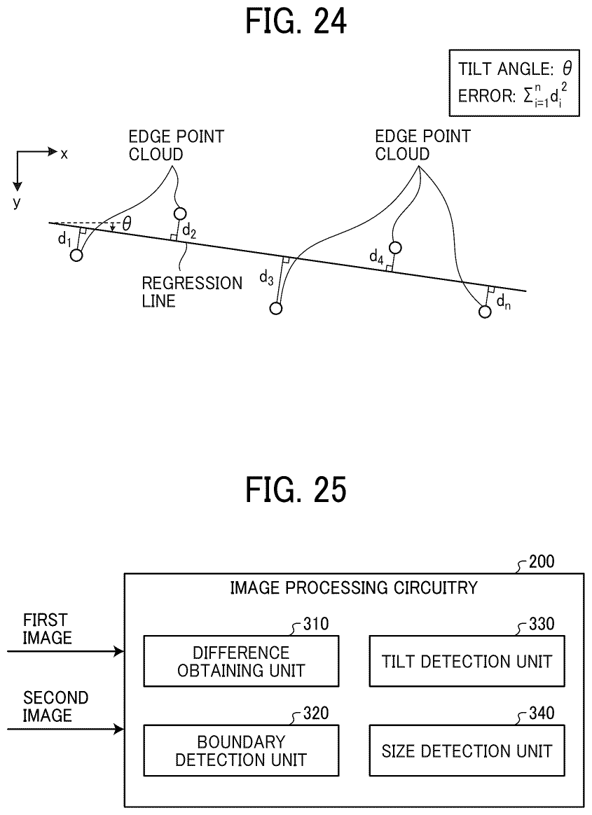

FIG. 24 is a diagram illustrating an example of the tilt angle θ determined from the edge point cloud. In FIG. 24, dᵢ (i=1, 2, . . . , n) denotes the distance between the regression line and the edge point clouds, and the regression line is determined to minimize an error that is calculated as a sum of squares of dᵢ. The tilt angle θ is a tilt with respect to the x-axis (e.g., an axis parallel to the upper side of the read image).

As described above, in the present embodiment, the tilt of the reading target can be accurately detected without any increase in the number of components and in processing cost when the difference in reflectance between the reading target and the background member is small across all the wavelengths of visible light and invisible light.

### Sixth Embodiment

A sixth embodiment will be described.

In the present embodiment, a size of the reading target is detected based on the boundary between the reading target and the background member detected by the image processor 120 according to the first to fourth embodiments. Description of part of the sixth embodiment similar to that of the fifth embodiment will be omitted, and part of the sixth embodiment different from that of the fifth embodiment will be described below.

FIG. 25 is a diagram illustrating an example of functional blocks of the image processing circuitry 200 according to the sixth embodiment. A difference between the sixth embodiment and the fifth embodiment is that the image processing circuitry 200 further includes a size detection unit 340.

The size detection unit 340 detects a size of the document based on the boundary between the document and the background detected by the boundary detection unit 320. The size of the document is, for example, a vertical length or a horizontal length of the document.

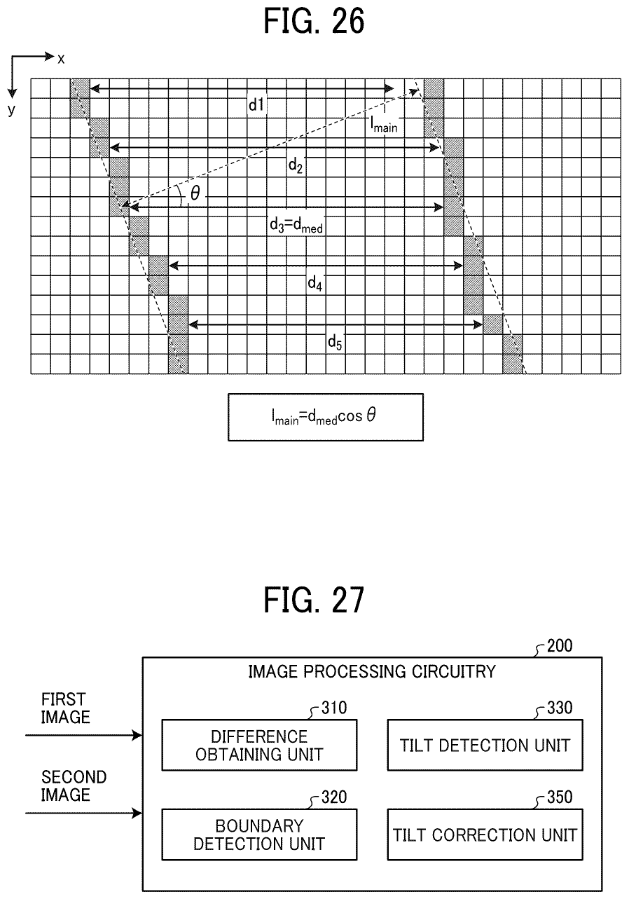

FIG. 26 is a diagram illustrating an example of size detection. Each square in FIG. 26 represents a pixel of an image (i.e., the difference image, the first image, or the second image) used for boundary detection. Each black pixel represents an edge point extracted in the boundary detection process. As illustrated in FIG. 26, for each pixel position in the y-axis direction, a distance dᵢ (i=1, 2, . . . ) between a left edge point and a right edge point of the document is determined, and a median d_{med} thereof is obtained. The size detection unit 340 calculates a horizontal length lₘₐᵢₙ of the document using Equation in FIG. 26 from the median d_{med} and the tilt angle θ detected by the tilt detection unit 330. The vertical length of the document can be calculated in the same manner.

As described above, in the present embodiment, the size of the reading target can be accurately detected without any increase in the number of components and in processing cost when the difference in reflectance between the reading target and the background member is small across all the wavelengths of visible light and invisible light. Since the size of the document is detectable using the read image or the like, a component for detecting the size is not to be added and the size of the document is detectable even for an irregularly shaped document.

### Seventh Embodiment

A seventh embodiment will be described.

In the present embodiment, a tilt of the reading target is corrected based on the boundary between the reading target and the background member detected by the image processor 120 according to the first to fourth embodiments. Description of part of the seventh embodiment similar to that of the fifth embodiment will be omitted, and part of the seventh embodiment different from that of the fifth embodiment will be described below.

FIG. 27 is a diagram illustrating an example of functional blocks of the image processing circuitry 200 according to the seventh embodiment. A difference between the seventh embodiment and the fifth embodiment is that the image processing circuitry 200 further includes a tilt correction unit 350.

The tilt correction unit 350 corrects the tilt of the document in at least one of the first image and the second image, based on the boundary between the document and the background detected by the boundary detection unit 320.

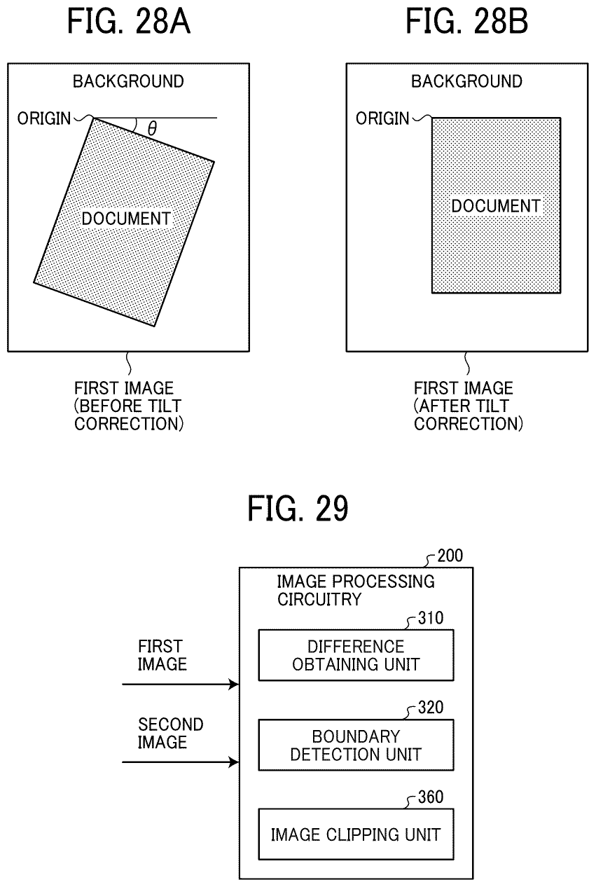

FIGS. 28A and 28B are diagrams illustrating an example of tilt correction. FIG. 28A illustrates an example of the first image before tilt correction. FIG. 28B illustrates an example of the first image after tilt correction. In this example, the tilt correction unit 350 rotates the image of the document about the origin, which is the intersection of the upper side and the left side of the document, using the tilt angle θ detected by the tilt detection unit 330 to perform tilt correction.

As described above, in the present embodiment, the tilt of the reading target can be accurately corrected without any increase in the number of components and in processing cost when the difference in reflectance between the reading target and the background member is small across all the wavelengths of visible light and invisible light. The use of the tilt-corrected read image can increase the readability of the document and the optical character recognition (OCR) accuracy based on the read image.

### Eighth Embodiment

An eighth embodiment will be described.

In the present embodiment, an image of the reading target is clipped based on the boundary between the reading target and the background member detected by the image processor 120 according to the first to fourth embodiments. Description of part of the eighth embodiment similar to those of the first to fourth embodiments will be omitted, and part of the eighth embodiment different from those of the first to fourth embodiments will be described below.

FIG. 29 is a diagram illustrating an example of functional blocks of the image processing circuitry 200 according to the eighth embodiment. A difference between the eighth embodiment and the first to fourth embodiments is that the image processing circuitry 200 further includes an image clipping unit 360.

The image clipping unit 360 clips an image of the document (document image) from at least one of the first image and the second image based on the boundary between the document and the background detected by the boundary detection unit 320.

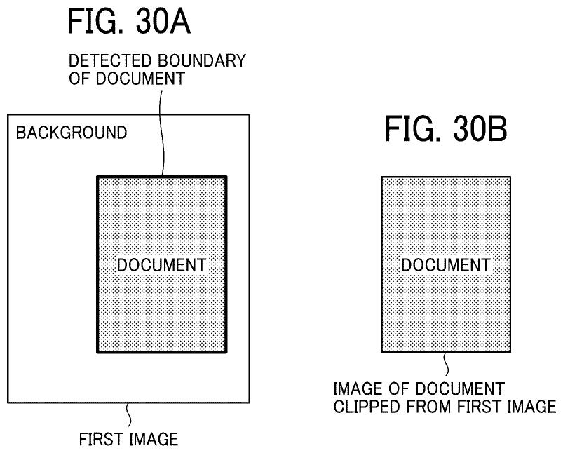

FIGS. 30A and 30B are diagrams illustrating an example of document image clipping. FIG. 30A illustrates an example of the boundary of the document detected in the first image. FIG. 30B illustrates an example of an image of the document clipped from the first image. As described above, the image clipping unit 360 clips the document image from the read image based on the boundary of the document detected by the boundary detection unit 320. Thus, the image data not including the background can be generated, leading to improved readability of the document and a reduced data amount.

As described above, in the present embodiment, the image of the reading target can be accurately clipped without any increase in the number of components and in processing cost when the difference in reflectance between the reading target and the background member is small across all the wavelengths of visible light and invisible light. In addition, the readability of the document can be improved and the amount of image data can be reduced.

### Ninth Embodiment

A ninth embodiment will be described.

In the present embodiment, the image processor 120 according to the first to eighth embodiments is used in a sorting apparatus that sorts reading targets such as packages. Description of part of the ninth embodiment similar to those of the first to eighth embodiments will be omitted, and part of the ninth embodiment different from those of the first to eighth embodiments will be described below.

In recent years, in fields of distribution and logistics, read images of packages have come to be used for operational efficiency. In the present embodiment, information on the boundaries of packages detected from read images is used for sorting the packages. In the present embodiment, examples of the packages include boxes including goods and products therein.

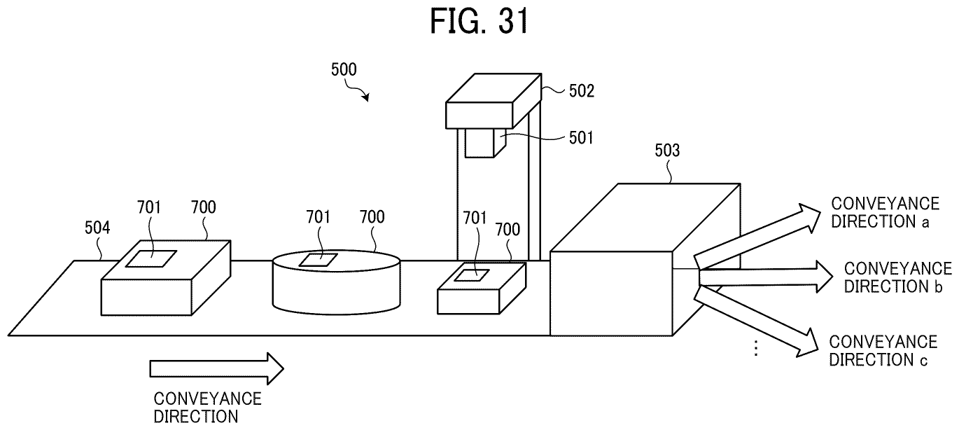

FIG. 31 is a diagram illustrating an example of a configuration of a sorting apparatus 500 according to the ninth embodiment. The sorting apparatus 500 includes an imager 501, a control device 502, a sorter 503, and a belt conveyor 504. The sorting apparatus 500 reads, with the imager 501, packages 700 that are reading targets conveyed on the belt conveyor 504, and switches and sorts, with the sorter 503, the packages 700 to a corresponding conveyance direction. Each of the packages 700 has a slip 701 attached thereto.

The control device 502 controls the operation of the sorting apparatus 500. The control device 502 includes the image processor 120 according to the first to eighth embodiments therein, and detects information such as the boundary of the package 700 and the boundary of the slip 701 from the read image of the package 700 obtained by the imager 501.

Based on the information on the boundaries detected by the control device 502, the sorter 503 sorts the packages 700. Specifically, the sorter 503 conveys each of the packages 700 in one of multiple conveyance directions a, b, and c illustrated in FIG. 31 to sort the packages 700. The sorting apparatus 500 includes belt conveyors respectively corresponding to the conveyance directions a, b, c, . . .

For example, the sorter 503 sorts the packages 700 using at least one of the following methods:
determining the shape of the package 700 based on the detected boundary, and sorting the package 700 in accordance with the determined shape (e.g., the shape viewed from above is rectangular or non-rectangular);
sorting the package 700 in accordance with the detected size of the package 700;
performing character recognition on the slip 701 by OCR, and sorting the package 700 in accordance with text information recognized from the tilt-corrected read image of the slip 701; and
performing character recognition on the slip 701 by OCR, and sorting the package 700 in accordance with text information recognized from the clipped read image of the slip 701.

As described above, in the present embodiment, the image processor 120 according to the first to eighth embodiments is used in the sorting apparatus 500 that sorts the reading target such as a package. This can make the work for sorting packages more efficient. The example in which the reading targets of the sorting apparatus 500 are the packages 700 has been described above. However, the reading targets are not limited to the packages 700 as long as the boundaries between the reading targets and the background member (the belt conveyor 504 in the present embodiment) are detectable.

In the embodiments described above, the reading target is conveyed and an image of the reading target is obtained by a fixed imager. Conversely, a method is adoptable in which the stationary reading target may be imaged by a moving imager to detect the boundary between the reading target and the background member.

An image processor (120) includes circuitry configured to obtain a difference image from a difference between a first image of an object and a background member read by a scanner at a first wavelength and a second image of the object and the background member read by the scanner at a second wavelength different from the first wavelength; and detect a boundary between the object and the background member based on the difference image obtained.

The circuitry is configured to receive, from the scanner, the first image having a first pixel value at a first pixel position and the second image having a second pixel value at a same position with the first pixel position; and subtract the second pixel value from first pixel value to obtain the difference between the first image and the second image.

The first wavelength includes a visible wavelength, and The second wavelength includes an invisible wavelength in an invisible range.

The invisible wavelength includes a wavelength of near-infrared light. the circuitry is further configured to select the first wavelength from multiple first candidates and the second wavelength from multiple second candidates and receive, from the scanner, the first image having a first pixel value at a first pixel position of the object and the second image having a second pixel value at a second pixel position of the background member, to maximize an absolute value of a difference between the first pixel value and the second pixel value in the difference image.

The circuitry is further configured to select at least one of the difference image, the first image, or the second image as a detection image; and detect the boundary, based on the detection image.

The circuitry is configured to detect a tilt of the object, based on the boundary detected.

The circuitry is configured to detect a size of the object, based on the boundary detected.

The circuitry is configured to correct the tilt of the object in at least one of the first image or the second image, based on the tilt detected.

The circuitry is configured to clip an image of the object from at least one of the first image or the second image, based on the boundary detected.

An image reading device (130) includes the image processor (120) and the scanner (101). The scanner includes a light source (24) to emit first light of the first wavelength and second light of the second wavelength to the object and the background member; and an imager (28) to image reflection light reflected from the object and the background member.

An image forming apparatus (100) includes the image reading device (130) and an image forming device (140) to form an image, based on image data processed by the image processor (120).

A sorting apparatus (500) includes the image reading device (130) and a sorter (503) to sort the object, based on the boundary detected.

An image processing method to be executed by an image processor, includes obtaining a difference image from a difference between a first image of an object and a background member read by a scanner at a first wavelength; and a second image of the object and the background member read by the scanner at a second wavelength different from the first wavelength; and detecting a boundary between the object and the background member based on the difference image obtained.

The light source emits the first light of the first wavelength including a visible wavelength and second light of the second wavelength including an invisible wavelength in an invisible range to the object and the background member.

The light source emits the second light of the second wavelength including the invisible wavelength including a wavelength of near-infrared light.

In the first to eighth embodiments, an example of the image processor according to the embodiments of the present disclosure that is applied to a multi-function peripheral (MFP) having at least two functions among a copy function, a printer function, a scanner function, and a facsimile function has been described. However, the image processor is applicable to any image forming apparatus such as a copier, a printer, a scanner, or a facsimile machine.

The programs executed by the image forming apparatus 100, the image processor 120, the image reading device 130, and the sorting apparatus 500 according to the embodiments may be recorded on and provided through a computer-readable recording medium such as a compact disc read-only memory (CD-ROM), a flexible disk (FD), a compact disc recordable (CD-R), or a digital versatile disc (DVD), in an installable or executable file format.

The programs executed by the apparatuses and devices according to the embodiments may be stored on a computer connected to a network such as the Internet and may be downloaded via the network and provided to the apparatuses and devices. The programs executed by the apparatuses and devices according to the embodiments may be provided or distributed via a network such as the Internet.

The programs according to the embodiments may be preinstalled and provided on the ROM or the like.

The programs executed by the apparatuses and devices according to the embodiments have a module configuration including the functional units described above. The CPU (processor) that is actual hardware reads the programs from the ROM and executes the programs, so that the above-described functional units are loaded to a main storage device and are generated in the main storage device.

Each of the functions of any one of the above-described embodiments can be implemented by one or more processing circuits or circuitry. As used herein, the term “processing circuit or circuitry” includes processors programmed to implement each function by software, such as a processor implemented by an electronic circuit, and devices designed to implement the functions described above, such as an application-specific integrated circuit (ASIC), a digital signal processor (DSP), a field programmable gate array (FPGA), and existing circuit modules.

Although some embodiments of the present disclosure have been described above, the above-described embodiments are presented as examples and are not intended to limit the scope of the present disclosure. Such novel embodiments may be carried out in various other modified forms. Various combinations, omissions, substitutions, and changes may be made without departing from the gist of the present disclosure. Such novel embodiments and modifications thereof are within the scope and gist of the present disclosure and are also within the scope of the claims and the equivalent thereof. The elements of different embodiments or modifications may be combined with each other as appropriate.

Aspects of the present disclosure are, for example, as follows.

According to Aspect 1, an image processor includes a difference obtaining unit and a boundary detection unit. The difference obtaining unit obtains a difference image from a difference between a first image and a second image. The first image is an image of a reading target and a background member read at a first wavelength. The second image is an image of the reading target and the background member read at a second wavelength different from the first wavelength. The boundary detection unit detects a boundary between the reading target and the background member, based on the difference image.

According to Aspect 2, in the image processor of Aspect 1, the difference includes a differential value obtained by subtracting a pixel value at each pixel position in the second image from a pixel value at a corresponding pixel position in the first image.

According to Aspect 3, in the image processor of Aspect 1 or 2, the first wavelength includes a wavelength in a visible range, and the second wavelength includes a wavelength in an invisible range.

According to Aspect 4, in the image processor of Aspect 3, the wavelength in the invisible range includes a wavelength of near-infrared light.

According to Aspect 5, the image processor of any one of Aspects 1 to 4 further includes a wavelength selection unit. The wavelength selection unit selects the first wavelength from among multiple first candidates and selects the second wavelength from among multiple second candidates. The wavelength selection unit selects the first wavelength and the second wavelength to maximize an absolute value of a difference between a pixel value of the reading target and a pixel value of the background member in the difference image.

According to Aspect 6, in the image processor of any one of Aspects 1 to 5, the boundary detection unit selects at least one of the difference image, the first image, or the second image as a detection image and detects the boundary, based on the detection image.

According to Aspect 7, the image processor of any one of Aspects 1 to 6, further includes a tilt detection unit. The tilt detection unit detects a tilt of the reading target, based on the boundary detected by the boundary detection unit.

According to Aspect 8, the image processor of any one of Aspects 1 to 7, further includes a size detection unit. The size detection unit detects a size of the reading target, based on the boundary detected by the boundary detection unit.

According to Aspect 9, the image processor of Aspect 7, further includes a tilt correction unit. The tilt correction unit corrects the tilt of the reading target in at least one of the first image or the second image, based on the tilt detected by the tilt detection unit.

According to Aspect 10, the image processor of any one of Aspects 1 to 7, further includes an image clipping unit. The image clipping unit clips an image of the reading target from at least one of the first image or the second image, based on the boundary detected by the boundary detection unit.

According to Aspect 11, an image reading device includes the image processor of any one of Aspects 1 to 10, a light source, and an imager. The light source irradiates the reading target and the background member with light of the first wavelength and light of the second wavelength. The imager images reflected light from the reading target and the background member.

According to Aspect 12, an image forming apparatus includes the image reading device of Aspect 11 and an image forming device. The image forming device forms an image, based on image data processed by the image processor.

According to Aspect 13, a sorting apparatus includes the image reading device of Aspect 11 and a sorter. The sorter sorts the reading target, based on the boundary detected by the boundary detection unit.

According to Aspect 14, an image processing method to be executed by an image processor, includes obtaining a difference image from a difference between a first image and a second image, the first image being an image of a reading target and a background member read at a first wavelength, the second image being an image of the reading target and the background member read at a second wavelength different from the first wavelength; and detecting a boundary between the reading target and the background member, based on the difference image.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An image processor comprising:
circuitry configured to:
obtain a difference image from a difference between:
a first image of an object and a background member read by a scanner at a first wavelength; and
a second image of the object and the background member read by the scanner at a second wavelength different from the first wavelength; and
detect a boundary between the object and the background member based on the difference image obtained.

2. The image processor according to claim 1, wherein:
the first image has a first pixel value at a first pixel position,
the second image has a second pixel value at a second pixel position corresponding to the first pixel position, and
the circuitry is configured to:
subtract the second pixel value from first pixel value to obtain the difference between the first image and the second image.

3. The image processor according to claim 1, wherein:
the first wavelength includes a visible wavelength, and
the second wavelength includes an invisible wavelength in an invisible range.

4. The image processor according to claim 3, wherein:
the invisible wavelength includes a wavelength of near-infrared light.

5. The image processor according to claim 1, wherein:
the circuitry is further configured to:
select:
the first wavelength from multiple first candidates; and
the second wavelength from multiple second candidates; and
receive, from the scanner:
the first image having a first pixel value at a first pixel position of the object; and
the second image having a second pixel value at a second pixel position of the background member,
to maximize an absolute value of a difference between the first pixel value and the second pixel value in the difference image.

6. The image processor according to claim 1, wherein:
the circuitry is further configured to:
select at least one of the difference image, the first image, or the second image as a detection image; and
detect the boundary, based on the detection image.

7. The image processor according to claim 1, wherein:
the circuitry is configured to:
detect a tilt of the object, based on the boundary detected.

8. The image processor according to claim 1, wherein:
the circuitry is configured to:
detect a size of the object, based on the boundary detected.

9. The image processor according to claim 7, wherein:
the circuitry is configured to:
correct the tilt of the object in at least one of the first image or the second image, based on the tilt detected.

10. The image processor according to claim 1, wherein:
the circuitry is configured to:
clip an image of the object from at least one of the first image or the second image, based on the boundary detected.

11. An image reading device comprising:
the image processor according to claim 1; and
the scanner including:
a light source to emit:
first light of the first wavelength; and
second light of the second wavelength,
to the object and the background member; and
an imager to image reflection light reflected from the object and the background member.

12. An image forming apparatus comprising:
the image reading device according to claim 11; and
an image forming device to form an image, based on image data processed by the image processor.

13. A sorting apparatus comprising:
the image reading device according to claim 11; and
a sorter to sort the object, based on the boundary detected.

14. An image processing method to be executed by an image processor, comprising:
obtaining a difference image from a difference between:
a first image of an object and a background member read by a scanner at a first wavelength; and
a second image of the object and the background member read by the scanner at a second wavelength different from the first wavelength; and
detecting a boundary between the object and the background member based on the difference image obtained.

15. The image reading device according to claim 11, wherein:
the light source emits:
the first light of the first wavelength including a visible wavelength; and
second light of the second wavelength including an invisible wavelength in an invisible range,
to the object and the background member.

16. The image reading device according to claim 15, wherein:
the light source emits the second light of the second wavelength including the invisible wavelength including a wavelength of near-infrared light.
